(19) United States
(12) Patent Application Publication
(10) Pub. No.: US 2013/0300144 A1
(43) Pub. Date: Nov. 14, 2013

(54) VEHICLE CONSOLE WITH STORAGE COMPARTMENT AND CONCEALED ARMREST HINGE

(71) Applicant: Benjamin Rose, Vermont (AU)

(72) Inventor: Benjamin Rose, Vermont (AU)

(73) Assignee: Ford Global Technologies, LLC, Dearborn, MI (US)

(21) Appl. No.: 13/466,165

(22) Filed: May 8, 2012

(51) Int. Cl. B60R 7/04; B23P 11/00

(52) U.S. Cl. 296/24.34; 29/428

(57) ABSTRACT

A storage console assembly for an automotive vehicle includes a console base, a rear panel enclosing the rear of the console base, a console mounting bracket mounted to a floor of the vehicle, a console bin disposed in the console base and defining a storage compartment, and a lid pivotally mounted to the console mounting bracket by a hinge. The lid encloses the console bin. The hinge has a console plate coupled to the console mounting bracket and a lid plate coupled to the lid. The console bin is configured to substantially conceal the hinge console plate from view by a vehicle occupant.

### FIELD OF THE INVENTION

The present invention generally relates to storage consoles typically mounted on the floor of an automotive vehicle, and more specifically to a console assembly with a concealed lid hinge.

### BACKGROUND OF THE INVENTION

Center floor consoles for automotive vehicles have become increasingly more sophisticated in their design, functionality, materials, and methods of construction. The floor console may include a storage compartment covered by a lid, which often doubles as an armrest. Typically, the lid is hinged at an upper portion of the floor console to allow access to the storage compartment, and the entire hinge, including the hinge plates, is generally visible. One common drawback of such floor consoles is the appearance degradation associated with both a visible hinge and visible fasteners, such as snap heads, screws, or clips.

### SUMMARY OF THE INVENTION

According to one aspect of the present invention, a vehicle console assembly is provided. The console assembly includes a console base attached to a mounting bracket and a console bin which defines a storage compartment. The console assembly also includes a lid pivotally mounted to the mounting bracket by a hinge. The hinge has a console plate attached to the mounting bracket and a lid plate attached to the lid. The console assembly is configured such that the console bin substantially conceals the console plate from view.

According to another aspect of the present invention, a storage console assembly for an automotive vehicle is provided. The storage console assembly includes a console base, a rear panel that encloses the rear of the console base, and a console mounting bracket mounted to a floor of the vehicle. The storage console assembly also includes a console bin disposed in the console base and which defines a storage compartment, and a lid pivotally mounted to the console mounting bracket by a hinge. The lid encloses the console bin. Further, the hinge has a console plate coupled to the console mounting bracket and a lid plate coupled to the lid, such that the console bin conceals the console plate from view by a vehicle occupant.

According to yet another aspect of the present invention, a method for assembling a storage console assembly to a vehicle is provided. The method includes mounting a console mounting bracket to a floor of the vehicle, affixing a console base to the console mounting bracket, affixing a console plate of a hinge to the console mounting bracket such that a lid is pivotally mounted to the console mounting bracket via a lid plate of the hinge, and affixing a rear panel to the console mounting bracket to enclose the rear of the console base. The method continues with installing a console bin into the console base.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a center storage console assembly disposed between two seats inside a vehicle;

FIG. 2 is an exploded view of the storage console assembly of FIG. 1, according to one embodiment;

FIG. 3 is a cross-sectional side view of the storage console assembly taken along line III-III of FIG. 1;

FIG. 4 is a top perspective view of a console bin of the storage console assembly of FIG. 1;

FIG. 5 is a partially exploded view of the storage console assembly of FIG. 1;

FIG. 6 is a top perspective view of the storage console assembly of FIG. 1, illustrating a lid of the storage console assembly in a closed position and an open position;

FIG. 7 is a partial cross-sectional side view of the storage console assembly, according to one embodiment; and

FIG. 8 is a flow diagram, illustrating a method of assembling the storage console assembly of FIG. 1, according to one embodiment.

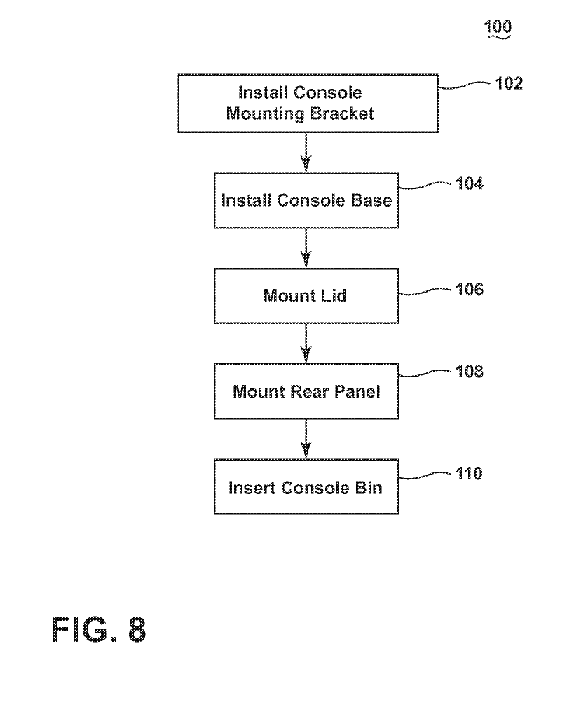

### DETAILED DESCRIPTION OF THE PREFERRED EMBODIMENTS

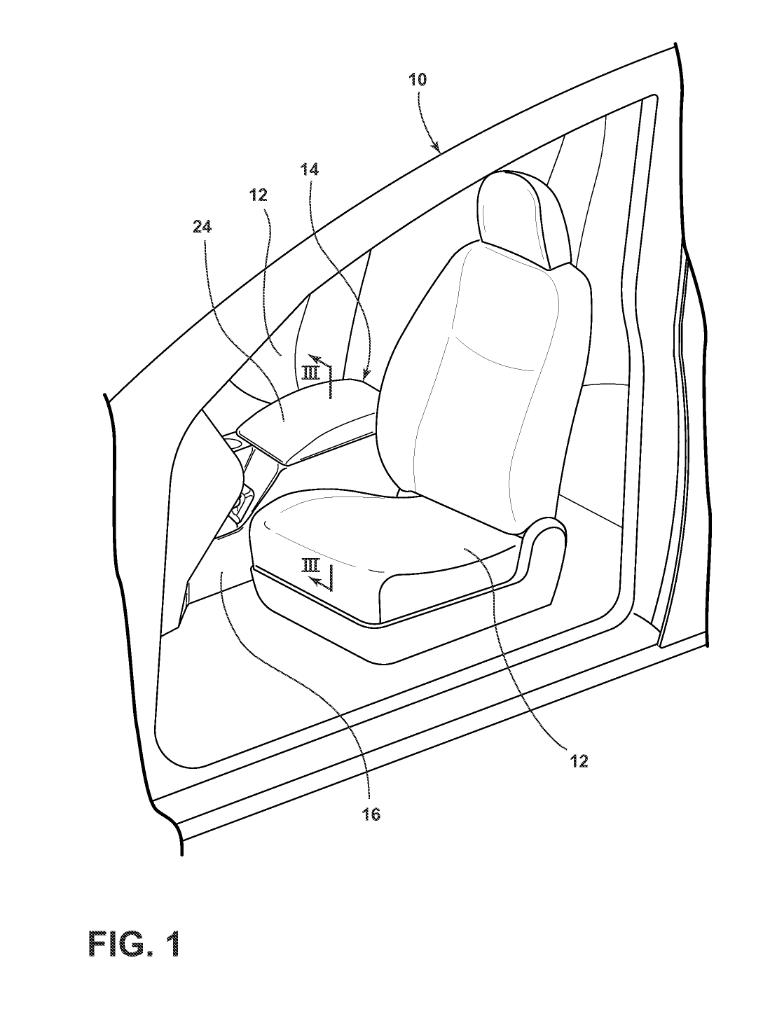

For purposes of description herein, the terms “upper,” “lower,” “right,” “left,” “rear,” “front,” “vertical,” “horizontal,” “interior,” “exterior,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

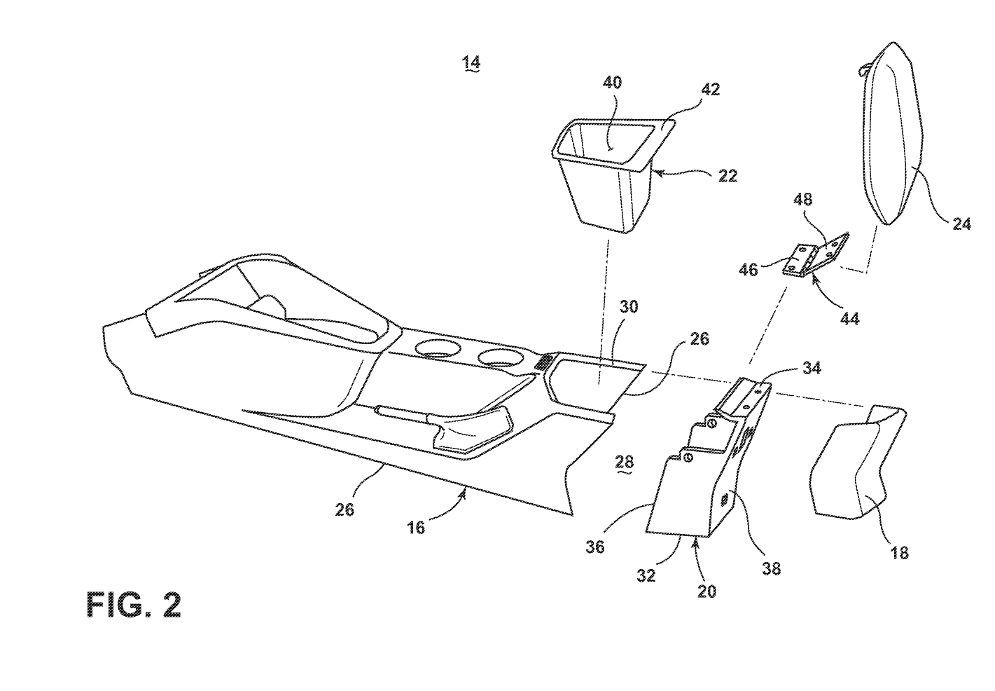

Referring now to the drawings, and in particular to FIGS. 1-2, the interior of an automotive vehicle 10 is shown having a pair of seats 12 with a center storage console assembly 14 disposed therebetween. The console assembly 14 includes a console base 16, a rear panel 18, a console mounting bracket 20, a console bin 22, and a lid 24. As known to those skilled in the art, various other components and features may also be included in the console assembly 14, for example a cupholder, climate control vent, hand brake, and gear shift.

The console base 16 has side walls 26 and the rear panel 18 encloses a rear portion of the console base 16. A cavity 28 is formed between the console base 16 and rear panel 18 and has an opening 30 at an upper portion thereof.

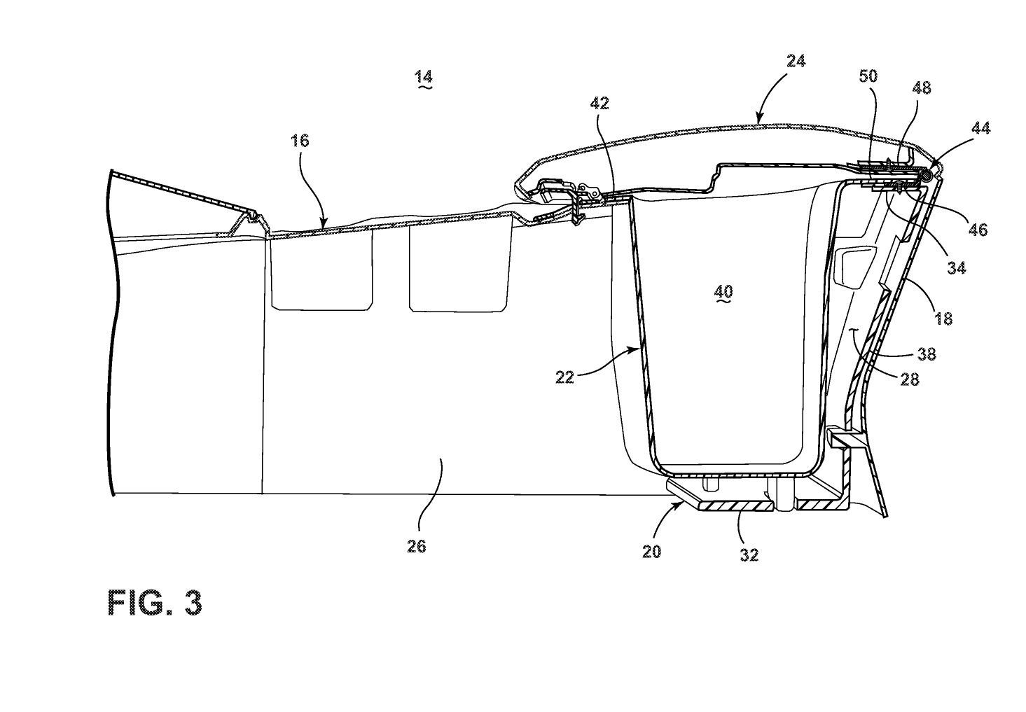

Referring now to FIGS. 2-3, the console mounting bracket 20 is a generally rectilinear member that is mounted to the floor of the vehicle 10 and extends vertically therefrom. The console mounting bracket 20 includes a bottom wall 32, a top wall 34, two upstanding side walls 36, a rear wall 38, and a plurality of conventional mounting bosses or apertures. The substantially horizontal bottom wall 32 is mounted to the floor of the vehicle by any suitable means, including welding or conventional mechanical fasteners. The rear wall 38 extends vertically from the bottom wall 32 and includes at least one mounting aperture. The top wall 34 is substantially horizontal and is disposed at a top portion of the rear wall 38. Additionally, the top wall 34 includes a plurality of mounting apertures. The side walls 36 extend up from the bottom wall 32 and also include at least one mounting aperture each. Further, the console mounting bracket 20 may be formed of a rigid plastic material or of metal.

The console base 16 is affixed at a rear portion thereof to the console mounting bracket 20. In the illustrated example, the console base 16 is mounted to the side walls 36 of the console mounting bracket 20 by mechanical fasteners, such as threaded bolts. It should be understood that the console base 16 will likely be affixed to the vehicle 10 in several other locations in addition to the location disclosed herein. The rear panel 18 is also affixed to the console mounting bracket 20, on the rearward face of the rear wall 38. In the illustrated example, the rear panel 18 is mounted to the rear wall 38 by mechanical fasteners, such as conventional pinch top clips. The side walls 26 of the console base 16 and the rear panel 18 align in a complementary interface, providing an aesthetically pleasing appearance. Notably, the fasteners utilized for affixing the console base 16 and rear panel 18 to the console mounting bracket 20 are not visible on the exterior of the storage console assembly 14.

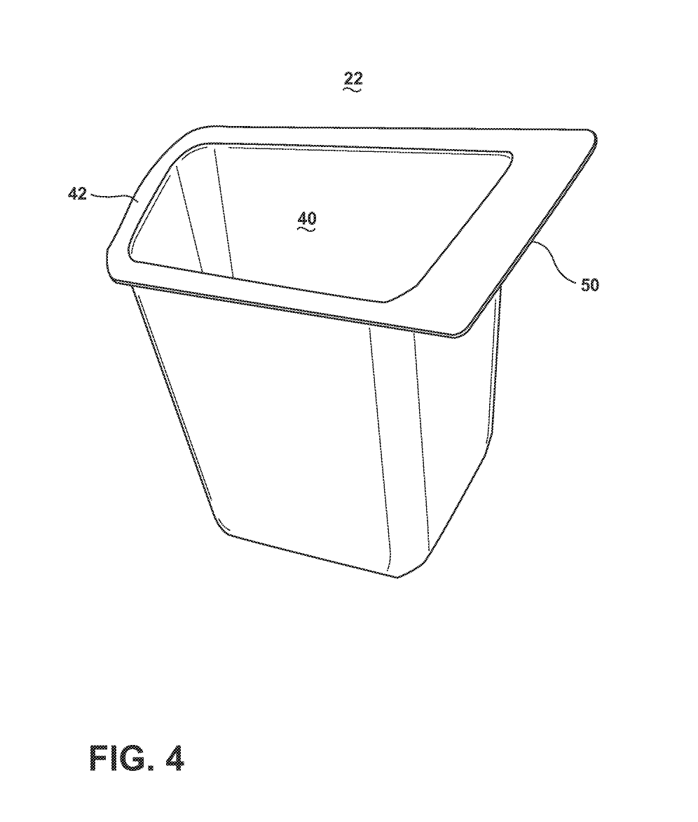

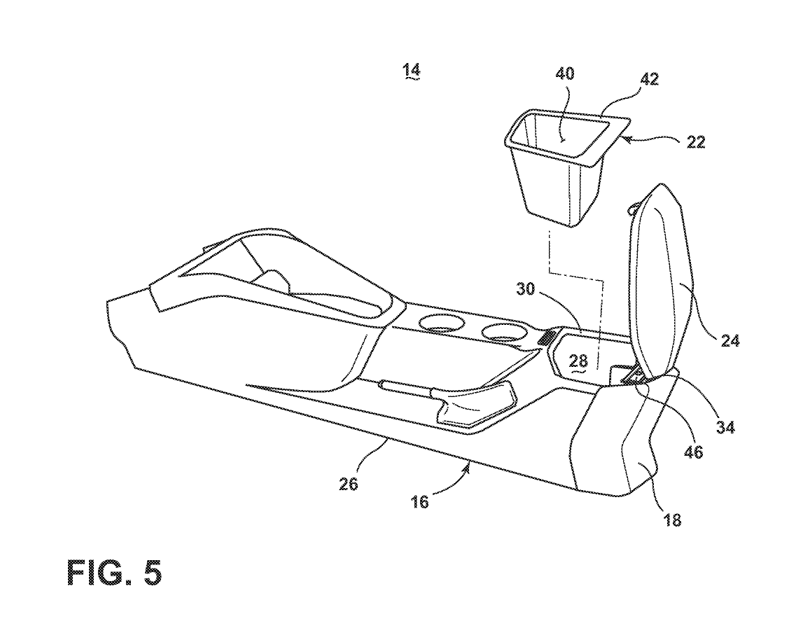

Referring now to FIGS. 4-5, the console bin 22 is a box-shaped member with an open top, defining a storage compartment 40 therewithin. A flange 42 is disposed around an upper portion of the console bin 22 and extends substantially horizontally therefrom. The console bin 22 may include one or more attachment means for coupling the console bin 22 to the console mounting bracket 20. For example, the console bin 22 may include ribs onto which pinch top clips can be installed, for attaching to apertures in the bottom wall 32 of the console mounting bracket 20. It should be noted that the attachment means are located on a lower, exterior surface of the console bin 22, and are not visible from the interior of the console bin 22. Additionally, the console bin 22 may be formed of any suitable plastic material, and may be provided in a variety of colors, textures, or surface finishes as it is visible from the interior of the vehicle 10. The flange 42 extends out from the perimeter of the console bin 22 and is designed to align with the console base 16 and rear panel 18 in an aesthetically pleasing manner. Additionally, the flange 42 may be designed to align flush, sub-flush, or above the upper surfaces of the console base 16 and rear panel 18.

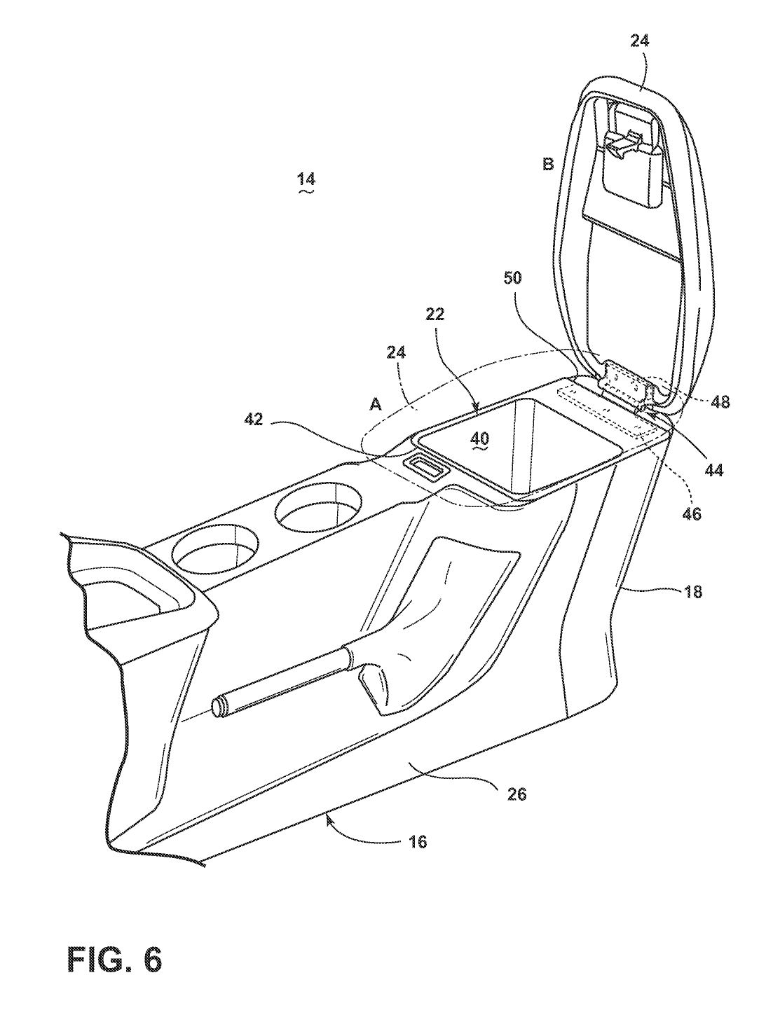

The console bin 22 is enclosed by a lid 24 which is moveable to cover and uncover the storage compartment 40, as illustrated in FIG. 6. Referring to both FIGS. 3 and 6, the lid 24 pivots between a closed position A and an open position B about a hinge 44 which has a console plate 46 attached to the top wall 34 of the console mounting bracket 20 and a lid plate 48 attached to an inner surface of the lid 24. The console and lid plates 46, 48 are mounted to the console mounting bracket 20 and lid 24 by any suitable attachment means, such as threaded fasteners. The hinge 44 is mounted at a rear portion of the console assembly 14, proximate the storage compartment 40, such that the lid 24 pivots upwardly between the closed position A and the open position B to allow access through the open top of the console bin 22 from an area forward of the storage compartment 40. The lid 24 may also include a latch, as is known by one having ordinary skill in the art.

The flange 42 is configured such that a rear portion 50 thereof is disposed between the console plate 46 and the lid plate 48. More specifically, the rear portion 50 is disposed above the console plate 46, thereby substantially concealing the console plate 46 and fastening means from view by an occupant of the vehicle 10 when the lid 24 is pivoted to the open position B. This configuration provides improved aesthetics by hiding nearly the entire console plate 46 from view by vehicle 10 occupants. It is contemplated that the rear portion 50 of the flange 42 may cover or conceal at least a portion of the console plate 46. For example, the rear portion 50 may overlap the console plate 46 as little as a few millimeters, or as much as the entire console plate 46. In the illustrated example best seen in FIG. 3, the rear portion 50 of the flange 42 is shown covering the entire console plate 46, extending right up to the pivot point.

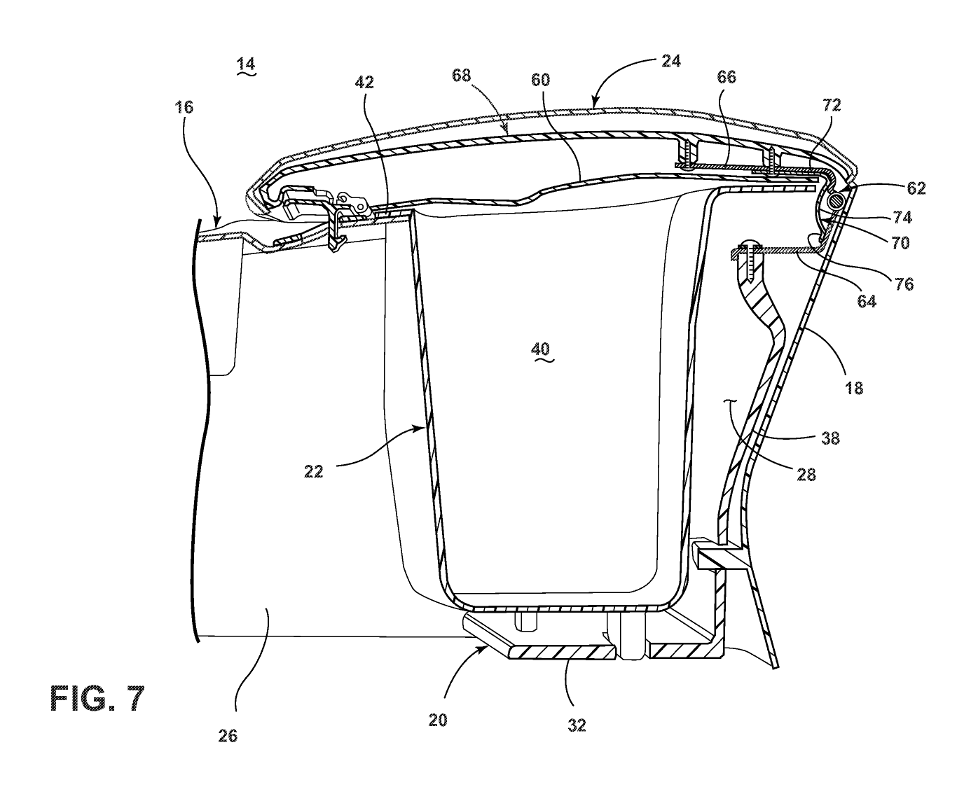

FIG. 7 illustrates another embodiment, where similar elements from the first embodiment are labeled with the same reference numerals. In this embodiment of the storage console assembly 14, the lid 24 also includes a lid liner 60. Additionally, the storage console assembly 14 includes a hinge 62 and a hinge close-out shroud 70. The hinge 62 is in the form of a combination gooseneck/piano hinge type hinge, as is understood by one skilled in the art. The hinge 62 has a console plate 64 attached to the top wall 34 of the console mounting bracket 20, and a lid plate 66 attached to an inner surface 68 of the lid 24. The console and lid plates 64 and 66 are mounted to the console mounting bracket 20 and lid 24 by any suitable attachment means, such as threaded fasteners. The lid liner 60 is positioned beneath the inner surface 68 of the lid 24, thereby concealing the lid plate 66 and fasteners from view by a vehicle occupant when the lid 24 is pivoted open.

The hinge close-out shroud 70 is an elongated member having a substantially horizontal portion 72 and an arcuate portion 74 extending down from the horizontal portion 72. The hinge close-out shroud 70 is also mounted, via the horizontal portion 72, to the inner surface 68 of the lid 24 by any suitable attachment means. Further, the arcuate portion 74 is configured such that it is disposed in front of the pivot point of the hinge 62. Accordingly, when the lid 24 is pivoted open, the hinge close-out shroud 70 pivots with the lid 24, and the arcuate portion 74 covers the hinge 62 throughout the entire path of travel. This prevents the hinge 62 from being visible through the space between the rear portion of the flange 42 of the console bin 22 and the lid liner 60 mounted to the lid 24, providing an aesthetically pleasing lid 24 pivot point. Additionally, the hinge close-out shroud 70 has a stop 76, which contacts the underside of the rear portion 50 of the flange 42, acting as a stop when the lid 24 reaches open position. According to another embodiment, a method 100 for assembling a storage console assembly 14 begins with a step 102 of mounting the console mounting bracket 20 to a floor of the vehicle 10, by means as described above. In step 104 the console base 16 is moved into position and affixed at a rear portion thereof with fasteners to the console mounting bracket 20. The lid 24 is mounted to the console mounting bracket 20 in step 106 by mounting the console plate 46 by fasteners to the top wall 34 of the console mounting bracket 20. The hinge 44, including the lid plate 48, may be assembled to the lid 24 prior to commencing the method 100. In step 108, the rear panel 18 is affixed with fasteners to the console mounting bracket 20, though realistically, this step could be performed at any time subsequent the installation of the console mounting bracket 20 in step 102. Last, the console bin 22 is installed into the cavity 28 of the console base 16, in step 110 covering a substantial portion of the hinge console plate 46. The method concludes once steps 102-110 have been completed.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A vehicle console assembly, comprising:
a console base attached to a mounting bracket and having a console bin defining a storage compartment;
a lid pivotally mounted to the mounting bracket by a hinge; and
the hinge comprising a console plate attached by fasteners to the mounting bracket and a lid plate attached to the lid, wherein the console bin conceals the fasteners and substantially conceals the console plate when the lid is pivoted open.

2. The vehicle console assembly of claim 1, wherein the console bin comprises front, side, rear, and bottom walls, and a flange disposed around an upper opening in the console bin.

3. The vehicle console assembly of claim 1 further comprising a rear panel enclosing the rear of the console base.

4. The vehicle console assembly of claim 1, wherein the console mounting bracket is mounted to a floor of the vehicle.

5. The vehicle console assembly of claim 1, wherein the lid plate is coupled to the lid by one or more fasteners; the lid comprising a lid liner disposed below the lid plate, thereby concealing the lid plate from view by a vehicle occupant when the lid is pivoted open.

6. The storage console assembly of claim 2, wherein a portion of the flange is disposed above the console plate, between the console plate and the lid.

7. The storage console assembly of claim 6, wherein the console plate is coupled to the console mounting bracket by one or more fasteners, and the flange conceals the one or more fasteners and substantially conceals the console plate from view by a vehicle occupant when the lid is pivoted open.

8. The storage console assembly of claim 7, wherein the console bin includes one or more fasteners disposed on an exterior surface thereof for affixing the console bin to the console mounting bracket.

9. The storage console assembly of claim 1, wherein the console bin and lid are adapted such that no fasteners are visible within the storage compartment and on the lid at least when the lid is pivoted open.

10. A storage console assembly for an automotive vehicle, comprising:
a console base;
a rear panel enclosing the rear of the console base;
a console mounting bracket mounted to a floor of the vehicle;
a console bin disposed in the console base and defining a storage compartment;
a lid pivotally mounted to the console mounting bracket by a hinge and defining open and closed positions, the lid enclosing the console bin when the lid is in the closed position; and
the hinge comprising a console plate coupled to the console mounting bracket by at least one fastener and a lid plate coupled to the lid, wherein the console bin conceals the console plate and the at least one fastener from view by a vehicle occupant at least when the lid is in the open position.

11. The storage console assembly of claim 10, wherein the console bin comprises front, side, rear, and bottom walls, and a flange disposed around an upper opening of the console bin.

12. The storage console assembly of claim 11, wherein a portion of the flange is disposed between the console plate and the lid plate, and the flange is disposed above the console plate.

13. The storage console assembly of claim 12, further comprising a lid liner disposed on a bottom surface of the lid, for concealing the lid plate from view by a vehicle occupant when the lid is pivoted open.

14. The storage console assembly of claim 12, wherein the console plate is coupled to the console mounting bracket by one or more fasteners, and the flange conceals the console plate and the one or more fasteners from view by a vehicle occupant when the lid is pivoted open.

15. The storage console assembly of claim 14, wherein the console bin includes at least one fastener disposed on an exterior surface thereof for affixing the console bin to the console mounting bracket such that no fastening means are visible within the storage compartment.

16. The storage console assembly of claim 10, further comprising a hinge close-out shroud mounted to the lid for concealing any portion of the hinge viewable between the console bin and the lid liner when the lid is pivoted open.

17. A method for assembling a storage console assembly to a vehicle, the method comprising:
mounting a console mounting bracket to a floor of the vehicle;
affixing a console base to the console mounting bracket;
affixing a console plate of a hinge to the console mounting bracket with at least one fastener, wherein a lid is pivotally mounted to the console mounting bracket via a lid plate of the hinge;
affixing a rear panel to the console mounting bracket to enclose the rear of the console base; and
installing a console bin comprising a flange disposed around an upper portion thereof into the console base, wherein the flange conceals the console plate and the at least one fastener from view by a vehicle occupant when the lid is pivoted open.

18. The method of claim 17, wherein the console bin flange is disposed above the console plate, between the console plate and the lid.

19. The method of claim 17, wherein the console bin is adapted such that no fastening means are visible within the storage compartment at least when the lid is pivoted open.

20. The method of claim 17, wherein the lid comprises a lid liner disposed on a bottom surface of the lid, for concealing the lid plate.
